(19) United States
(12) Patent Application Publication
(10) Pub. No.: US 2006/0170987 A1
(43) Pub. Date: Aug. 3, 2006

(54) Scanner and scan module thereof

(75) Inventor: Yung-Shun Ho, Nantou County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/345,440

(22) Filed: Feb. 1, 2006

(30) Foreign Application Priority Data
Feb. 3, 2005 (TW) 94103359

(51) Int. Cl. H04N 1/04

(52) U.S. Cl. 358/474

(57) ABSTRACT

A scanner. An optical sensor is adjacent to a glass plate, and a support element supporting the optical sensor. A first magnet is disposed on the optical sensor, and a second magnet corresponding to the first magnet is disposed on the support element. The first magnet faces the second magnet with the magnetic poles of the same polarity disposed opposingly, thereby maintaining a predetermined distance between the optical sensor and the glass plate.

### BACKGROUND

The invention relates to a scanner, and in particular to a scanner utilizing magnets to maintain a predetermined distance between an optical sensor and an object to be scanned.

The optical quality of a scanner depends on maintaining a constant distance between an optical sensor thereof and the object to be scanned and smooth motion of the optical sensor, particularly for the scanners utilizing contact image sensors (CIS). A very short distance must be maintained between the CIS and the scanned object to function normally and obtain excellent scan quality.

Referring to FIG. 1, a conventional scan module 10 directed by a guide bar 30, is movably disposed in a housing 20. Two spacers 50 disposed between the scan module 10 and the glass plate 40 maintain a predetermined distance therebetween. Referring to FIG. 2, the scan module 10 comprises a CIS 12, a support element 14, a spring 16 and a holder 18. The guide bar 30 joins and moves along the support element 14 via the holder 18. The CIS 12 is supported by the support element 14. The spring 16 disposed between the CIS 12 and the support element 14 biases the CIS 12 to the glass plate 40 bearing a scanning object 70 via the spacer 50, whereby a constant distance between the CIS 12 and the scanning object 70 is maintained.

Other methods of maintaining a constant distance between a CIS and a scanning object can be seen in R.O.C. patent No. 347945 and R.O.C. patent No. 352887.

### SUMMARY

The invention provides another structure for maintaining a constant distance between an optical sensor (CIS) and a scanning object.

A scanner according to an embodiment of the invention comprises a glass plate, an optical sensor adjacent to the glass plate, a support element supporting the optical sensor, a first magnet disposed on the optical sensor, and a second magnet corresponding to the first magnet and disposed on the support element, wherein the first magnet faces the second magnet with magnetic poles of the same polarity disposed opposingly to exert a magnetic repulsive force on the optical sensor.

A scanner according to an embodiment of the invention further comprises a spacer disposed between the optical sensor and the glass plate, maintaining a predetermined distance therebetween.

The first and second magnets are fixed on the optical sensor and the support element respectively by double-side adhesives.

The support element comprises a compartment accommodating the second magnet, and an inner wall of the compartment serves as a guide wall for force balance of the first and second magnets.

### BRIEF DESCRIPTION OF THE DRAWINGS

The invention can be more fully understood by reading the subsequent detailed description and examples with references made to the accompanying drawings, wherein:

FIG. 1 is a schematic view of a conventional scanner with a contact image sensor;

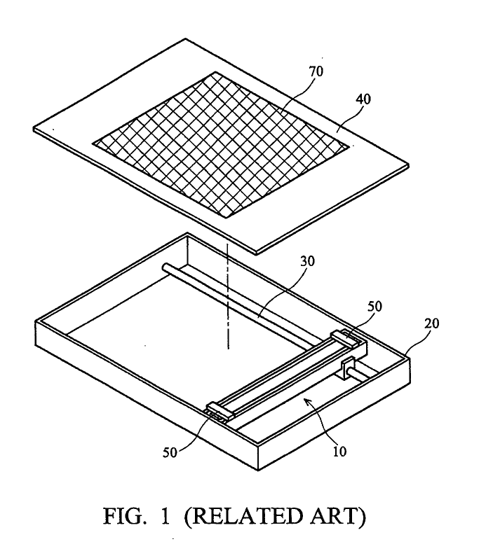

FIG. 2 is an exploded perspective view of a conventional scanner;

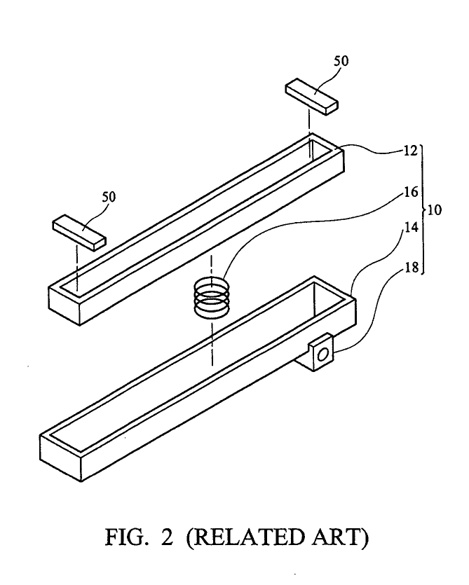

FIG. 3 is a cross section of a scanner according to an embodiment of the invention; and

FIG. 4 is an exploded perspective view of a scan module according to an embodiment of the invention.

### DETAILED DESCRIPTION

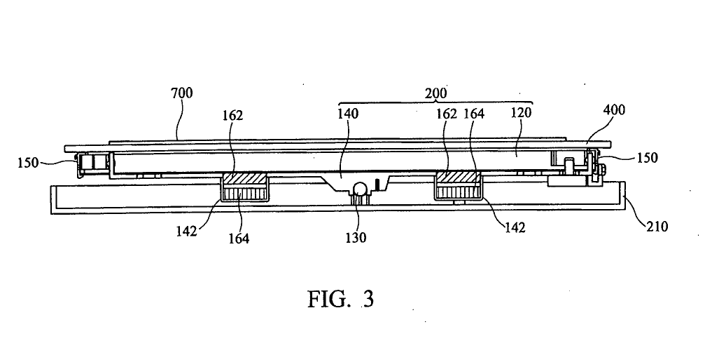

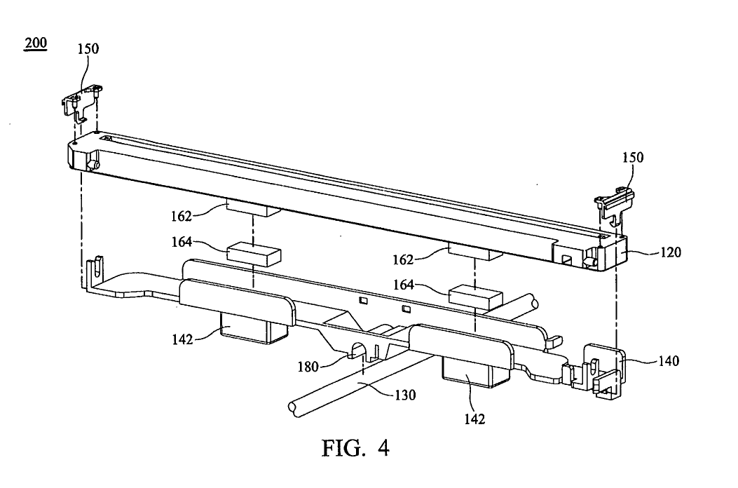

Referring to FIGS. 3 and 4, a scanner 1000 comprises a scan module 200, a guide bar 130, a spacer 150, a housing 210 and a glass plate 400 bearing an object for scanning. The scan module 200 is directed by the guide bar 130 and is movably disposed in the housing 210. Spacer 150 maintains a constant distance to the scanned object.

Referring to FIG. 4, the scan module 200 comprises an optical sensor (CIS) 120, a support element 140, two first magnets 162 and two second magnets 164. The optical sensor 120 is disposed in the support element 140 comprising two compartments 142 accommodating the second magnets 164. The first magnet 162 corresponding to the second magnet 164 is disposed on the bottom of the optical sensor 120. The first magnet 162 faces the second magnet 164 with magnetic poles of same polarity opposite disposed, for example, the north pole of the first magnet pole 162 is positioned downwardly and the north pole of the second magnet 164 is positioned upwardly. A yoke 180 is disposed on the support element 140 to hold the guide bar 130, whereby the support element 140 is capable of moving along the guide bar 130. The spacer 150 is disposed between the optical sensor 120 and the glass plate 400 bearing scanning object 700 to maintain a constant distance therebetween.

Referring to FIG. 3, when the optical sensor 120 is on the supporting element 140, because the magnetic poles with same polarity of the first and second magnets 162 and 164 are disposed opposingly, repulsive force between the magnetic poles pushes the optical sensor 120 upward to abut the spacer 150, thereby maintaining a constant distance between the optical sensor 120 and the glass plate 400.

The first and second magnets 162, 164 are fixed on the optical sensor 120 and support element 140 respectively by adhesives. Since the second magnet 164 is accommodated in the compartment 142, an inner wall of the compartment 142 serves as a guide wall for force balance between the first and second magnets 162 and 164. Although in this embodiment adhesives are applied to fix the first and second magnets 162, 164 to the optical sensor 120 and support element 140, it is not limited thereto, other methods and/or materials can also be applied.

The invention provides another structure for the CIS scanner, which utilizes the repulsive force between two magnets to maintain a constant distance between an optical sensor and a scanned object.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scan module, comprising:
an optical sensor;
a support element supporting the optical sensor;
a first magnet disposed on the optical sensor; and
a second magnet corresponding to the first magnet and disposed on the support element, wherein the first magnet faces the second magnet with the magnetic poles of the same polarity disposed opposingly to exert a magnetic repulsive force on the optical sensor.

2. The scan module as claimed in claim 1, wherein the first and second magnets are fixed adhesively on the optical sensor and the support element respectively.

3. The scan module as claimed in claim 1, wherein the support element comprises a compartment accommodating the second magnet, and an inner wall of the compartment serves as a guide wall for force balance between the first and second magnets.

4. The scan module as claimed in claim 1, wherein the optical sensor comprises a contact image sensor (CIS).

5. The scan module as claimed in claim 1, wherein the first and second magnets are permanent magnets.

6. A scanner, comprising:
a glass plate;
an optical sensor under the glass plate;
a support element supporting the optical sensor;
a first magnet disposed on the optical sensor; and
a second magnet corresponding to the first magnet and disposed on the support element, wherein the first magnet faces the second magnet with the magnetic poles of the same polarity disposed opposingly to exert a magnetic repulsive force on the optical sensor.

7. The scanner as claimed in claim 6 further comprising a spacer between the optical sensor and the glass plate, wherein the optical sensor is pushed by the magnetic repulsive force to abut the spacer.

8. The scanner as claimed in claim 6, wherein the first and second magnets are fixed adhesively on the optical sensor and the support element respectively.

9. The scanner as claimed in claim 6, wherein the support element comprises a compartment accommodating the second magnet, and an inner wall of the compartment serves as a guide wall for force balance between the first and second magnets.

10. The scanner as claimed in claim 6, wherein the optical sensor comprises a contact image sensor (CIS).

11. The scanner as claimed in claim 6, wherein the first and second magnets are permanent magnets.
